(19) United States
(12) Patent Application Publication
(10) Pub. No.: US 2012/0128927 A1
(43) Pub. Date: May 24, 2012

(54) AIR PERMEABLE ELASTIC LAMINATE AND FABRICATING METHOD THEREOF

(75) Inventors: Yuen-Lun Tasi, Taipei City (TW); Hui-Ming Yen, Taipei City (TW); Wei-Yu Chen, Taipei City (TW)

(73) Assignees: Eric Shyuu, Taipei City (TW); Kenneth Cheng, Taipei City (TW)

(21) Appl. No.: 12/950,065

(22) Filed: Nov. 19, 2010

(51) Int. Cl. B32B 3/10; B32B 38/04

(52) U.S. Cl. 428/131; 156/229

(57) ABSTRACT

An air permeable elastic laminate and a fabricating method thereof are disclosed. At least two materials having different elasticity coefficients are combined to form an elastic laminate. A thermal melting processing technique is utilized to perform a local thermal treatment to the elastic laminate so as to form a plurality of hardened parts on the elastic laminate. A stretch stress is applied to the elastic laminate in order to break the hardened parts. The elastic laminate is elastically recovered after the stretch stress is released. The air permeability is provided to the elastic laminate through the broken hardened parts, and the unhardened parts on the elastic laminate still have elasticity.

### BACKGROUND OF THE INVENTION

1. Field of the Invention

The present invention relates to an air permeable elastic laminate, and a method for fabricating an elastic laminate having air permeability.

2. The Prior Arts

In the disposable product market sectors, the needs for better-fitting and more comfortable disposable hygiene products, such as disposable diapers, and infant learning pants, have increased. As such, a laminate having high elasticity, high elastic recovery rate and high air permeability can satisfy these needs. Generally, the elastic laminate is also expected to be elastically stretchable in dual directions. Disposable personal care products and health care products usually have enough air permeability and strength to be used for general purposes. The air permeability refers to the rate of passage of air or water vapor through fabric. The strength is relative to the tensile strength. In theory, the above-mentioned properties of the polymer films of the laminate can be individually enhanced, but it is hard to maintain the strength of the laminate and increase the air permeability of the polymer films at the same time. For example, when one polymer film has a better air permeability compared to other polymer films, the tensile property of the one polymer film can be expected to be weak. On the other hand, when a polymer film has a better tensile property, the air permeability thereof becomes lower. As a result, there is always a need for fabricating personal care products or health care products using the elastic laminates having good air permeability and strength.

In the past, a method for endowing the nonwoven fabric laminate with high tensile property would often damage the structure of the laminate, and thereby the strength of the laminate is lowered, especially the tensile strength. Moreover, the laminates fabricated by conventional methods do not have sufficient elastic recovery rate, and thereby they can not be effectively used in the desired application.

Before combining an elastic film or a nonwoven fabric to form a laminate, hole-punching to the elastic film or the nonwoven fabric is a commonly used technique for providing air permeability to the laminate. However, the through holes may cause the whole strength of the laminate to decrease so that the laminate cannot meet the use demand.

Moreover, in the conventional hole-punching method, after the hole punching process is carried out, the residual materials may be left at edges of the holes of the elastic film or the nonwoven fabric, and thereby the additional cleaning or trimming process is required after the hole-punching process. Furthermore, the numbers of punched holes can not be precisely controlled, and also the processing efficiency for punching holes is low.

Furthermore, the hole-punching process can be carried out after combining an elastic film or a nonwoven fabric to form a laminate in order to endow the laminate with air permeability. However, the tear points may appear on the laminate after hole-punching process, which results in poor tensile strength.

Accordingly, there is a need for developing a laminate having high elasticity and a method for fabricating the laminate having high elasticity and elastic recovery rate in order to meet the needs of disposable product market. Moreover, the tear points existing in the laminate fabricated by the conventional method have to be reduced. Furthermore, the complicated processes for fabricating the laminate should be simplified while the desired properties (high air permeability and high tensile strength) are kept.

### SUMMARY OF THE PRESENT INVENTION

Accordingly, the present invention provides an elastic laminate including at least two different elasticity coefficients of materials. When fabricated, the elastic laminates of the present invention are strong enough, and have sufficient tensile strength and air permeability to meet different application needs.

One feature of the air-permeable elastic laminate of the present invention comprises at least one elastic nonwoven fabric and an elastic film including elastic polymer combined together. The elastic nonwoven fabric can use the elastic nonwoven fabric disclosed in U.S. Pat. No. 6,746,978. According to the present invention, the laminate can have single-direction elasticity (e.g. horizontal direction), or bi-direction elasticity (e.g. horizontal and vertical directions) due to the properties of the elastic nonwoven fabric. The laminates, which are just stacked together, can have good elasticity and good elastic recovery properties without further processing treatments. Comparing with a quasi elastic laminate fabricated by the conventional methods using the non-elastic material which was stretched out or hole-punched, the elastic laminate of the present invention has better elastic performance and the fabricating method thereof can be simplified.

Another feature of the present invention is that the elastic laminate can be formed with a plurality of layers of elastic nonwoven fabrics, and the elastic laminate of the present invention can have single-direction or bi-direction elasticity according to the properties of the elastic nonwoven fabrics.

One solution provided by the present invention is to apply a local hot pressing to the laminate just formed so as to form a plurality of hardened parts on the laminate. Then, a stretch stress is applied to the elastic laminate, such that the hardened parts formed on the elastic laminate are broken due to the brittleness of the press-hardened parts generated by locally hot-melting and cooling. The elastic laminate is elastically recovered after the stretch stress is released. The air permeability is generated by breaking the hardened parts, and because the unbroken parts of the laminate still have good elasticity, the high tensile strength of the laminate is kept.

Another solution provided by the present invention is to place an elastic laminate on a surface of a jig having a plurality of concave holes. Audio wave energy is utilized to pass through the elastic laminate, such that the material's molecular structures of the elastic laminate at the locations corresponding to the concave holes on the surface of the jig are changed with the change of electronic energy levels, so that the hardened parts of the laminate are formed on the locations where the concave holes are disposed. Then the elastic laminate is applied with a stretch stress for breaking the hardened parts. The elastic laminate is elastically recovered after the stretch stress is released.

The combination of the elastic nonwoven fabric and the elastic film containing elastic polymer for forming the elastic laminate of the present invention can be achieved by attaching them via ultrasonic wave, hot pressing, electrically discharging, electronic beam, or static electricity.

The shape of the hardened parts formed on the elastic laminate can be in the points, lines, or any other geometric shapes, or the combination thereof.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a schematic view of the embodiment of the present invention illustrating the laminate being formed through combining an elastic nonwoven fabric and an elastic film containing elastic polymer;

FIG. 2 is a schematic view of the embodiment of the present invention illustrating the laminate being formed through combining an elastic film containing elastic polymer between two elastic nonwoven fabrics;

FIG. 3 is a schematic view of the embodiment of the present invention illustrating an ultrasonic equipment being utilized to apply audio frequency to the laminate so as to form a plurality of hardened parts on the laminate;

FIG. 4A is a lateral cross sectional view of the structure of the laminate after being formed with the plural hardened parts;

FIG. 4B is a top view of the structure of the laminate after being formed with the plural hardened parts;

FIG. 5A is a lateral cross sectional view illustrating the laminate formed with the hardened parts being applied with stretch stress for breaking the hardened parts;

FIG. 5B is a top view illustrating the laminate formed with the hardened parts being applied with a stretch stress for breaking the hardened parts;

FIG. 6 is a schematic view of the embodiment of the present invention illustrating the hardened parts formed on the laminate can be an arranged combination of various shapes; and

FIG. 7 is a schematic view of an embodiment of the present invention illustrating forming the hardened parts on the laminate through the thermal melting technique.

### DETAILED DESCRIPTION OF THE PREFERRED EMBODIMENT

The accompanying drawings are included to provide a further understanding of the invention, and are incorporated in and constitute a part of this specification. The drawings illustrate embodiments of the invention and, together with the description, serve to explain the principles of the invention.

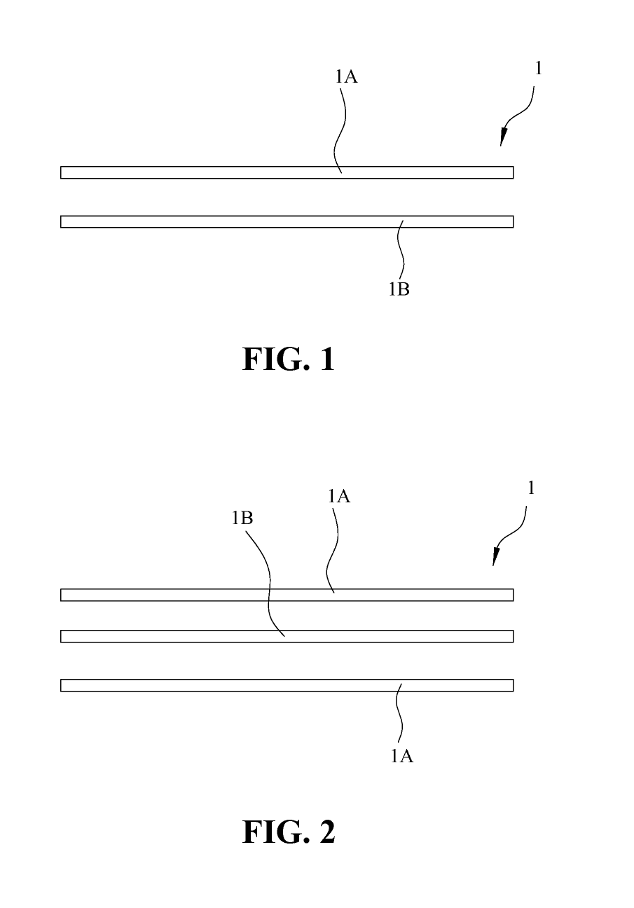

As shown in FIG. 1, the elastic laminate 1 of the embodiment of the present invention is formed by stacking an elastic nonwoven fabric 1A, and an elastic film 1B containing elastic polymer and having an elasticity coefficient different from that of the elastic nonwoven fabric 1A together. Also as shown in FIG. 2, the elastic laminate 1 of the embodiment of the present invention is formed by stacking an elastic film 1B containing elastic polymer and two elastic nonwoven fabrics 1A together, wherein the elastic film 1B is sandwiched by the two elastic nonwoven fabrics 1A, and the elastic laminate 1 of the embodiment of the present invention can be also formed by stacking a plurality of layers of the elastic films and a plurality of layers of the elastic nonwoven fabrics to form a multi-layer elastic laminate; or formed by stacking a plurality of layers of elastic nonwoven fabrics to form an elastic laminate. The weight percentage of the elastic polymer contained in the elastic film 1B is preferably greater than 15% by weight. The attachment of the elastic nonwoven fabric 1A to the elastic film 1B can be achieved by applying adhesives to the two engaging surfaces and then adhering them; or by matching the two engaging surfaces with each other and then attaching them by ultrasonic wave, hot pressing, electrically discharging, electronic beam, static electricity, or chemical catalyst. Moreover, the elastic polymer can be applied to the surfaces of the elastic nonwoven fabric by blown film extrusion, cast film extrusion, foam extrusion, or direct cast extrusion.

The elastic nonwoven fabric 1A is made of short chemical fibers or/and long chemical fibers. The elastic nonwoven fabric naturally has properties of extensibility and high elastic recovery property. The fibers of nonwoven fabric can be single polymer, bicomponent, or blended fibers.

The elastic film 1B can be made of several types of elastic polymers. But the fluids such as air or liquid cannot permeate into the material used. In this embodiment, an elastic polyurethane film having a thickness of 0.02 to 0.03 mm is used. In another embodiment, the elastic film 1B can be composed of a plurality of film. Other elastic materials can also be used for fabricating the elastic film, e.g. a single-layer elastic member or a foamed plastic layer, but the films have to be made of materials capable of preventing air or liquid from permeating.

The elastic film 1B can also be composed of the films of high elastic compounds, such as a block copolymer, which is composed of long sequences (“blocks”) of the same monomer unit (A), covalently bound to sequences of unlike type monomer unit (B). The blocks can be connected in a variety of ways; schematics of AB diblock and ABA triblock structures. Generally, these compounds exhibit excellent elastic recovery property. When being extruded as a single layer, the extension can exceed 100% while the elasticity and the elastic recovery property are still kept. In a specific embodiment, the elastic material includes high-performance elastic materials, e.g. styrene/isoprene/styrene, styrene/isoprene/butadiene or styrene/ethylene-butene/styrene (SIS, SIB or SEBS) or the elastic resin (Kraton™ manufactured by Kraton chemical Co.), which are all elastic block copolymers. The special configuration of the block copolymer provides the functionality to the main body.

Other useful elastic composition used for the elastic film 1B includes ethylene copolymer, e.g. ethylene vinyl acetate, ethylene/propene copolymer or ethylene/propene/diene terpolymer. The present invention can use a mixture of the above-mentioned copolymers or a mixture of the above-mentioned copolymers mixing with other modified elastic or non-elastic materials for fabricating the elastic film of the present invention.

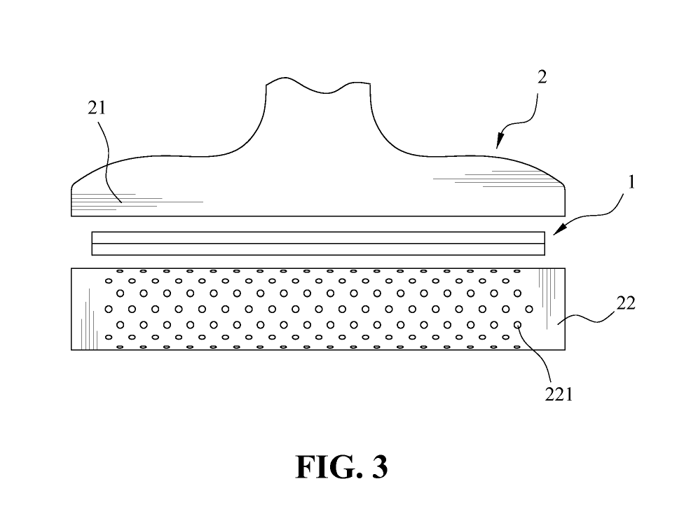

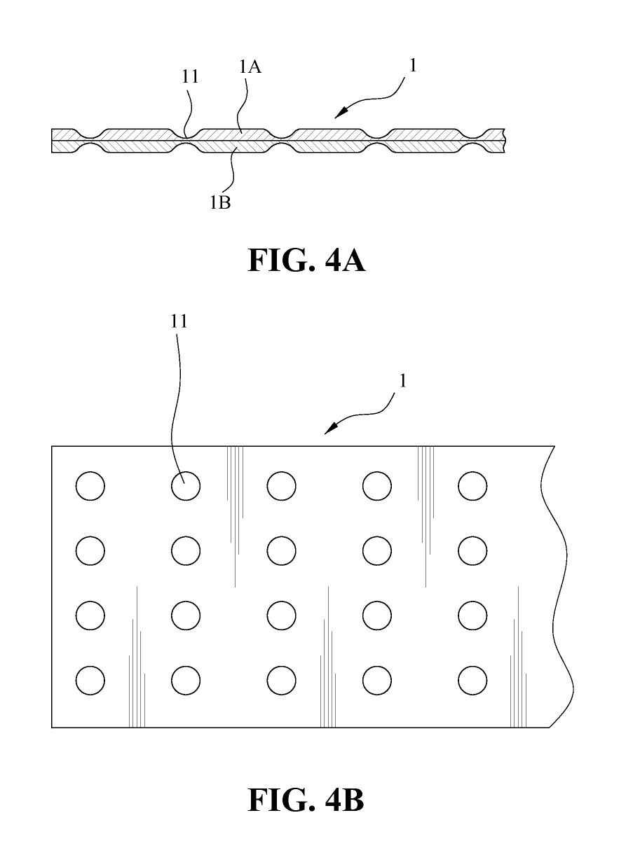

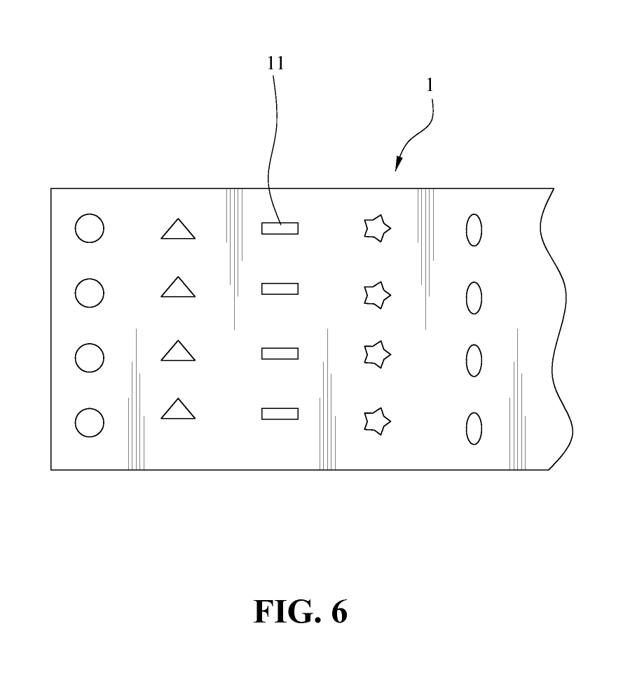

In the present invention, a plurality of the brittle hardened parts 11 with relatively weak strength on the elastic laminate as compared with the unhardened parts on the elastic laminate can be formed by an ultrasonic equipment which can be used for economical and massive manufacturing process. As shown in FIG. 3, the ultrasonic equipment 2 includes an ultrasonic wave generating device 21 and at least one roller 22. The outer surface of the roller 22 has a plurality of holes 221. The holes 221 can be designed to various shapes according to the need of the user. When the elastic laminate 1 is processed to form the plurality of the brittle hardened parts, the elastic laminate 1 passes between the ultrasonic wave generating device 21 and the roller 22 while being contact with the surface of the roller 22, and the roller 22 is driven to convey the elastic laminate 1. During the convey process of the elastic laminate 1 by the roller 22, the audio frequency is generated by the ultrasonic wave generating device 21. After the wave energy of the audio frequency reaches to the elastic laminate 1, the electronic energy levels for the material's molecules in the parts of the elastic laminate 1, which are corresponding to the holes 221 and are not blocked by the roller 22, are easily changed, thus material properties are changed, such that the recesses corresponding to the shapes of the holes 221 are formed. The surfaces of the recesses are relatively brittle, hard and have relatively weak strength, thus the hardened parts 11 are formed (as shown in FIG. 4A and FIG. 4B). the shapes of the holes 221 corresponding to the hardened parts 11 can be round or can be linear, triangular, oval, rectangular, or star-shape, or the combination thereof (as shown in FIG. 6). The shapes of the hardened parts 11 can be changed by replacing the roller 22 having different shapes of holes 221.

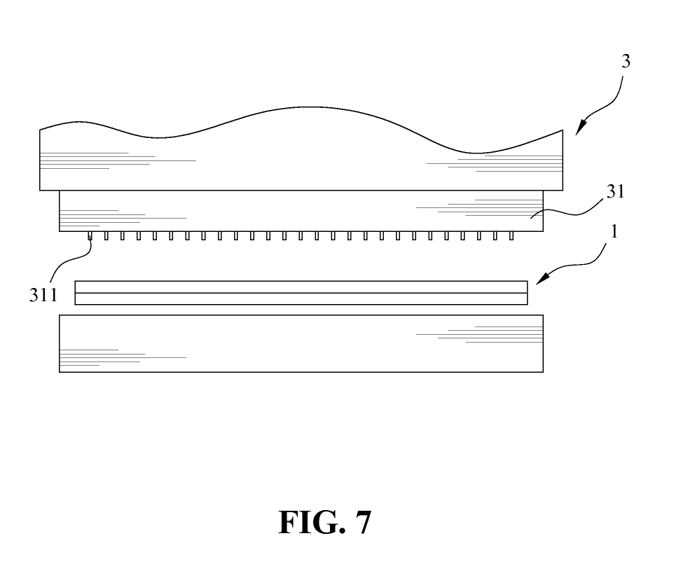

The preset invention can also utilize a hot pressing technique to perform a partial hot pressing treatment to the elastic laminate 1 so as to form a plurality of hardened parts on the elastic laminate 1. As shown in FIG. 7, a heating device 31 is installed on a hot pressing equipment 3, and the heating device 31 is provided with a plurality of heat-conductive molds 311, the distal surfaces of the molds 311 are formed with the desired shapes for the hardened parts 11. When the hot pressing is carried out, the elastic laminate 1 passes through under the molds 311, the heating device 31 along with the molds 311 are driven to descend, such that the distal surfaces of the molds 311 are properly pressed against the elastic laminate 1, and the heating device 31 transmits thermal energy to the elastic laminate 1 through the molds 311. After being heated, the elastic laminate 1 is melted and the material's molecular structure is changed. After the molds 311 are removed from the elastic laminate 1, the melted parts of the elastic laminate 1 are cooled so as to form the hardened parts 11.

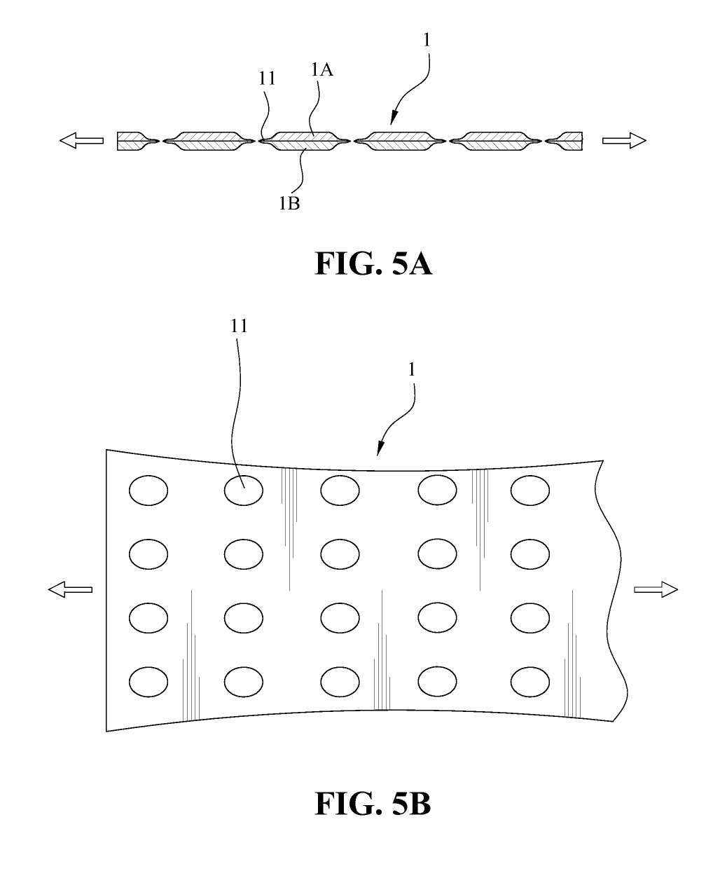

After the elastic laminate 1 with a plurality of hardened parts 11 is formed, two opposite ends of the elastic laminate 1 are applied with stretch forces in opposite directions through a stretching equipment so as to generate a proper stretch stress. Because the elastic laminate 1 has elasticity, stretching deformations are generated on the elastic laminate 1 when subjected to the stretch stress, and the hardened parts 11 are damaged or broken due to fragileness and having different elasticity coefficients (referring to FIG. 5A and FIG. 5B), and thus the slits generated in the hardened parts 11 after stretch will allow air to pass through. After the hardened parts 11 are broken, the stretch stress is released to let the elastic laminate 1 to restore itself. In the embodiment of the present invention, the stretch deformation rate of the elastic laminate 1 is greater than 20% after the stretch stress is released; the permanent deformation rate of the laminate is very low.

For providing the air permeability to the elastic laminate 1, the area of the hardened parts 11 preferably occupies 5% to 35% of the total surface area of the elastic laminate 1.

When the water vapor permeation rate of the air permeable elastic laminate fabricated by the method of the present invention is measured, the laminate exhibits commercially acceptable air permeability. In the present invention, the parameters, which include the change of the weight of the elastic nonwoven fabric, the selection of polymers of the elastic film, the thickness of the elastic film, and the size, quantity and distribution of the hardened parts, can be adjusted according to the desired applications.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A method for fabricating an air permeable elastic laminate, comprising:
combining at least two materials having different elasticity coefficients to form an elastic laminate;
performing a local treatment to the elastic laminate so as to form a plurality of hardened parts having relatively weak strength and relatively low elasticity coefficient on the elastic laminate as compared with the unhardened parts on the elastic laminate by utilizing a technique for changing material's molecular structures; and
applying a stretch stress to the elastic laminate in order to break the hardened parts, and the elastic laminate being elastically recovered after the stretch stress is released.

2. The method according to claim 1, wherein the technique for changing material's molecular structures is an ultrasonic technique, in which a plurality of locations of the elastic laminate are applied with audio frequency, and electronic energy levels for the material's molecules are changed to form the hardened parts of the elastic laminate.

3. The method according to claim 1, wherein the technique for changing material's molecular structures is a hot pressing technique, in which hot molds are pressed to a plurality of locations of the elastic laminate, such that the material's molecule structures at the locations where pressure and thermal energy are applied are changed to form the hardened parts of the elastic laminate.

4. The method according to claim 1, wherein the at least two materials having different elasticity coefficients includes an elastic nonwoven fabrics and an elastic film.

5. The method according to claim 1, wherein a weight percentage of an elastic polymer contained in the elastic film is greater than 15% by weight.

6. The method according to claim 1, wherein a shape of the hardened parts includes round-, linear-, triangular-, oval-, rectangular-, or star-shape, or a combination thereof.

7. The method according to claim 1, wherein the hardened parts occupy 5% to 35% of total surface area of the elastic laminate.

8. An air permeable elastic laminate, comprising at least two materials having different elasticity coefficients, the elastic laminate having a plurality of broken hardened parts for providing air permeability.

9. The air permeable elastic laminate according to claim 8, wherein the shape of the hardened parts includes round-, linear-, triangular-, oval-, rectangular-, or star-shape, or a combination thereof.

10. The air permeable elastic laminate according to claim 8, wherein the hardened parts occupy 5% to 35% of total surface area of the elastic laminate.
